(19) United States
(12) Patent Application Publication
(10) Pub. No.: US 2025/0249523 A1
(43) Pub. Date: Aug. 7, 2025

(54) METHOD FOR PRODUCING ACTIVE METAL CERAMIC SUBSTRATE

(71) Applicant: TONG HSING ELECTRONIC INDUSTRIES, LTD., Taipei City (TW)

(72) Inventors: CHIH-WEI MAO, Taipei City (TW); TSUNG-YING CHANG, Taipei City (TW); CHUNG-HO WEI, Taipei City (TW); MING-YI HSU, Taipei City (TW); CHI-WEN HUANG, Taipei City (TW)

(21) Appl. No.: 18/657,946

(22) Filed: May 8, 2024

(30) Foreign Application Priority Data
Feb. 6, 2024 (TW) 113104571

(51) Int. Cl. B23K 1/00; B23K 35/02; B23K 35/30; B23K 101/36; B23K 103/00

(52) U.S. Cl. CPC B23K 1/0016; B23K 35/025; B23K 35/302; B23K 2101/36; B23K 2103/52

(57) ABSTRACT

A method for producing an active metal ceramic substrate includes: coating a first solder paste prepared by mixing a first metal solder material and a first organic medium onto a ceramic substrate, and drying the first solder paste to form a first sub-solder layer; coating a second solder paste prepared by mixing a second metal solder material and a second organic medium onto the first sub-solder layer, and drying the second solder paste to form a second sub-solder layer; and disposing a conductive metal layer onto the second sub-solder layer, so as to form the active metal ceramic substrate. The first metal solder material includes a first active metal. The second metal solder material includes a metal tin and a metal copper, and selectively includes a second active metal. The first metal solder material and the second metal solder material do not contain any metal silver.

### CROSS-REFERENCE TO RELATED PATENT APPLICATION

This application claims the benefit of priority to Taiwan Patent Application No. 113104571, filed on Feb. 6, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for producing a metal ceramic substrate, and more particularly to a method for producing an active metal ceramic substrate.

### BACKGROUND OF THE DISCLOSURE

With the promotion of energy-saving and carbon reduction policies in various countries, the global market for electric vehicles (EV) is currently booming. In recent years, as major automakers successively launch 800-volt high-voltage vehicle products, demands for silicon carbide (SiC) ceramic substrate materials have grown rapidly.

However, for power devices that are based on the silicon carbide (SiC) ceramic substrate materials, requirements on a voltage, a frequency, and an operating temperature thereof are constantly increased. Hence, the ceramic substrate materials also need to be improved in terms of heat dissipation and reliability.

In the related art, conventional direct-bonding-copper (DBC) ceramic substrates are prepared by eutectic bonding, and there is no bonding material between a copper layer and a ceramic substrate. However, in the process of a high-temperature operation, a large thermal stress is often generated due to differences in thermal expansion coefficients between the copper layer and the ceramic substrate (e.g., Al₂O₃ or AlN), which causes the copper layer to peel off from a surface of the ceramic substrate. Therefore, the conventional direct-bonding-copper (DBC) ceramic substrates can no longer meet packaging requirements of high temperature, high power, high heat dissipation, and high reliability.

Currently, the conventional direct-bonding-copper (DBC) ceramic substrates are gradually being replaced in popularity by active metal brazing (AMB) substrate materials. Active metal elements (e.g., Ti, Zr, Ta, Nb, V, or Hf) of the active metal brazing substrate materials can wet a side surface of a ceramic substrate, so as to braze an ultra-thick copper foil onto the ceramic substrate at a high temperature. A brazing layer formed between the ultra-thick copper foil and the ceramic substrate through the active metal brazing process has a high connection strength.

In conventional active metal brazing paste materials, a silver-copper-titanium (Ag—Cu—Ti) metal composite material is commonly used. In the above-mentioned silver-copper-titanium metal composite material, a silver content usually exceeds 50 wt % (weight percent concentration), and can even exceed 70 wt %.

A brazing temperature of the conventional active metal brazing paste material that adopts the silver-copper-titanium (Ag—Cu—Ti) metal composite material is usually greater than 900° C. (e.g., 915° C.). Since a brazing layer formed of the conventional active metal brazing paste material contains a large amount of silver (i.e., a noble metal), material and manufacturing costs of the active metal brazing ceramic substrates remain high. Furthermore, the problem of electro-migration caused by silver (Ag) residue after an etching process has long been an issue that needs be solved.

### SUMMARY OF THE DISCLOSURE

In response to the above-referenced technical inadequacies, the present disclosure provides a method for producing an active metal ceramic substrate.

In order to solve the above-mentioned problems, one of the technical aspects adopted by the present disclosure is to provide a method for producing an active metal ceramic substrate. The method includes: coating a first solder paste prepared by mixing a first metal solder material and a first organic medium onto a side surface of a ceramic substrate, and drying the first solder paste to form a first sub-solder layer; coating a second solder paste prepared by mixing a second metal solder material and a second organic medium onto a side surface of the first sub-solder layer that is away from the ceramic substrate, and drying the second solder paste to form a second sub-solder layer; and disposing a conductive metal layer onto a side surface of the second sub-solder layer that is away from the first sub-solder layer, so as to form the active metal ceramic substrate. The first metal solder material includes a first active metal, and does not contain a metal silver (Ag). A thickness of the first sub-solder layer is between 1 micrometer and 10 micrometers. The second metal solder material includes a metal tin (Sn) and a metal copper (Cu), and selectively includes a second active metal, and the second metal solder material does not contain a metal silver (Ag). A thickness of the second sub-solder layer is between 6 micrometers and 24 micrometers.

Therefore, in the method for producing the active metal ceramic substrate provided by the present disclosure, by virtue of “coating a first solder paste onto a side surface of a ceramic substrate, and drying the first solder paste to form a first sub-solder layer, in which the first solder paste is prepared by mixing a first metal solder material and a first organic medium, the first metal solder material includes a first active metal and does not contain a metal silver (Ag), and a thickness of the first sub-solder layer is between 1 micrometer and 10 micrometers” and “coating a second solder paste onto a side surface of the first sub-solder layer that is away from the ceramic substrate, and drying the second solder paste to form a second sub-solder layer, in which the second solder paste is prepared by mixing a second metal solder material and a second organic medium, the second metal solder material includes a metal tin (Sn) and a metal copper (Cu), and selectively includes a second active metal, the second metal solder material does not contain a metal silver (Ag), and a thickness of the second sub-solder layer is between 6 micrometers and 24 micrometers,” a metal solder layer of the active metal ceramic substrate does not require the use of the metal silver (Ag).

Through the configuration of the first sub-solder layer and the second sub-solder layer in the above-mentioned metal solder layer, the metal solder layer can improve a bonding force between the ceramic substrate and the conductive metal layer. It is worth mentioning that since the metal solder layer does not contain any metal silver (Ag), an issue of electro-migration caused by silver residue in the related art can be effectively avoided, and the manufacturing costs can be reduced.

Lastly, through etching a circuit pattern on the ceramic substrate by exposure and development, the active metal ceramic substrate of the present disclosure can be applied to a high-power module for energy conversion, an electric vehicle, and a charging system.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing an active metal ceramic substrate according to an embodiment of the present disclosure;

FIG. 2A to 2E are schematic views showing the method for producing the active metal ceramic substrate according to the embodiment of the present disclosure; and

FIG. 3 is a schematic view showing two metal solder layers being respectively formed on both sides of the active metal ceramic substrate according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Method for Producing Active Metal Ceramic Substrate

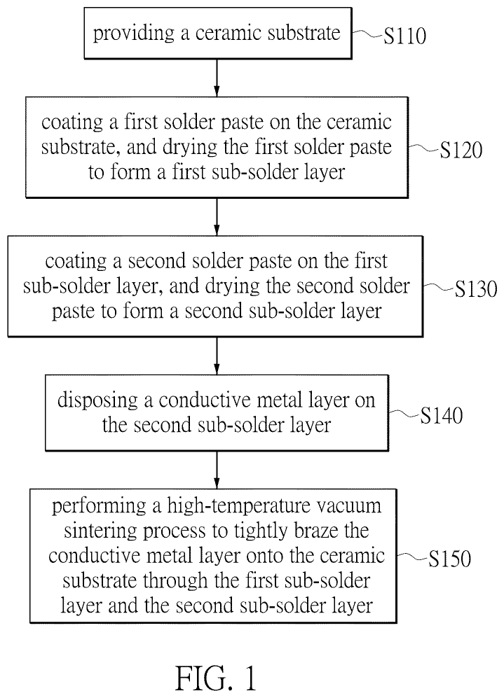

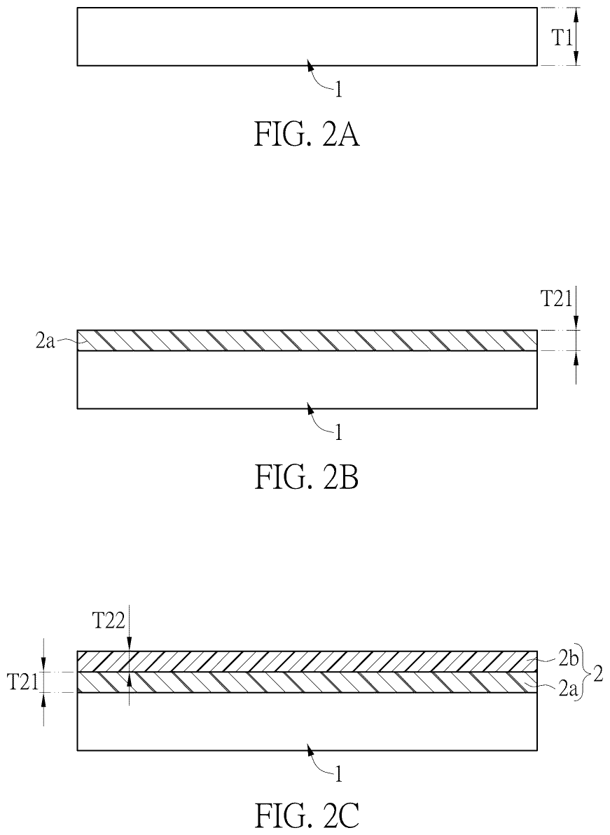

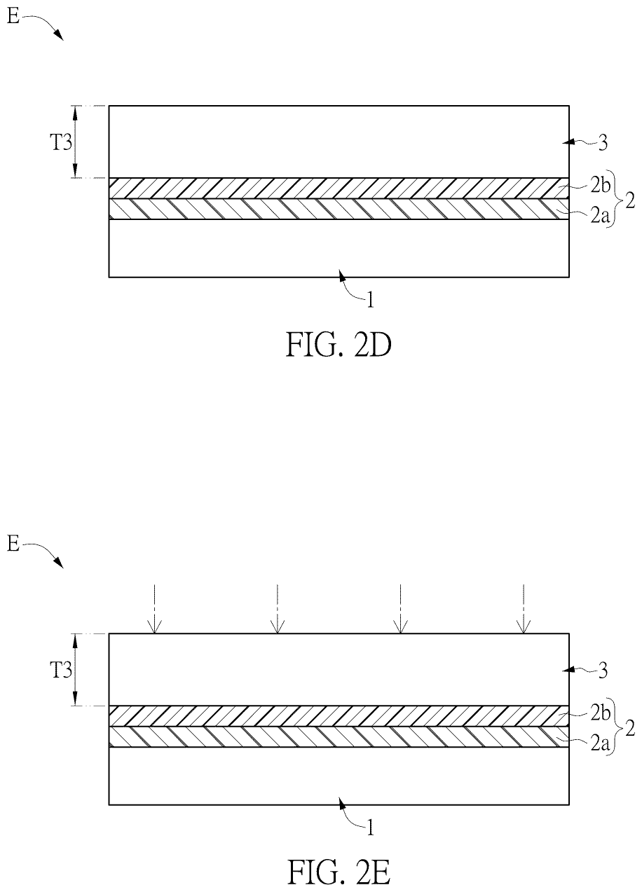

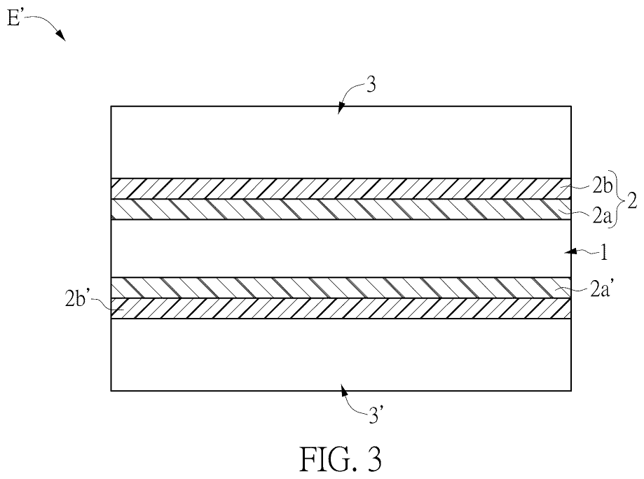

As shown in FIG. 1 and FIG. 2A to FIG. 2E, an embodiment of the present disclosure provides a method for producing an active metal ceramic substrate, which includes step S110, step S120, step S130, step S140, and step S150.

As shown in FIG. 1 and FIG. 2A, step S110 includes: providing a ceramic substrate 1. The ceramic substrate 1 can be at least one of a silicon nitride (SiN) ceramic substrate, a silicon carbide (SiC) ceramic substrate, an aluminum nitride (AlN) ceramic substrate, and an aluminum oxide (Al₂O₃) ceramic substrate.

In the present embodiment, the ceramic substrate 1 is preferably the silicon nitride (SiN) ceramic substrate. Furthermore, a thickness T1 of the ceramic substrate 1 is between 100 micrometers and 1,000 micrometers.

As shown in FIG. 1 and FIG. 2B, step S120 includes: coating a first solder paste onto a side surface of the ceramic substrate 1, and drying the first solder paste at a high temperature to remove a substantial amount of an organic solvent in the first solder paste, so that the first solder paste is formed into a first sub-solder layer 2a.

The first solder paste is prepared by mixing a first metal solder material and a first organic medium. The first metal solder material includes a first active metal, and is preferably formed by the first active metal only. In addition, the first solder paste does not contain any metal silver (Ag).

In some embodiments, the first active metal can be selected from the group consisting of: titanium (Ti), zirconium (Zr), tantalum (Ta), niobium (Nb), vanadium (V), hafnium (Hf), and a metal hydride of any one of the above-mentioned metals. For example, the metal hydride can be selected from the group consisting of: titanium hydride (TiH₂), zirconium hydride (ZrH₂), tantalum hydride (TaH₂), niobium hydride (NbH), vanadium hydride (VH₂), and hafnium hydride (H₂Hf₂). Preferably, the first active metal is at least one of titanium (Ti) and titanium hydride (TiH₂).

In the present embodiment, the first active metal is dispersed in the first organic medium in the form of metal powders, so as to prepare the first solder paste.

Furthermore, the first organic medium includes a paste forming agent, a thixotropic agent, and an organic solvent.

In the first organic medium, a weight ratio of the paste forming agent, the thixotropic agent, and the organic solvent is 20 to 30:1 to 5:50 to 70.

The paste forming agent can be selected from the group consisting of: silicone oil, white oil, polyvinyl alcohol, acrylic resin, nitrocellulose, ethyl cellulose, dimethyl phthalate, and carboxy-methyl cellulose. Preferably, the paste forming agent is ethyl cellulose.

The thixotropic agent can be selected from the group consisting of: polyamide wax, hydrogenated castor oil, and polyurea. Preferably, the thixotropic agent is polyamide wax.

The organic solvent can be selected from the group consisting of: ethylene glycol butyl ether acetate, diethylene glycol, tri-ethanolamine, butyl cellosolve, tert-butanol, N,N-dimethylformamide, terpineol, and nonyl phenol polyethylene glycol ether. Preferably, the organic solvent is terpineol or ethylene glycol butyl ether acetate.

Specifically, in the first solder paste, a weight ratio of the first metal solder material and the first organic medium is 70:30 to 95:5, and preferably is 80:20 to 90:10.

Preferably, the first solder paste is formulated to have a viscosity of between 50 mPa·s and 300 mPa·s (at a room temperature of 25° C.), so that the first solder paste can be easily coated onto the ceramic substrate 1, and shape formation can be easily achieved.

In one embodiment of the present disclosure, the first solder paste can be coated onto the side surface of the ceramic substrate 1 by screen printing, and can be dried at a high temperature of between 90° C. and 110° C. for 5 minutes to 15 minutes, so that most of the organic solvent in the first solder paste is volatilized, and the first sub-solder layer 2a can be formed. A thickness T21 of the first sub-solder layer 2a is between 1 micrometer and 10 micrometers, and is preferably between 1 micrometer and 6 micrometers.

As shown in FIG. 1 and FIG. 2C, step S130 includes: coating a second solder paste onto a side surface of the first sub-solder layer 2a that is away from the ceramic substrate 1, and drying the second solder paste at a high temperature to remove a substantial amount of an organic solvent in the second solder paste, so that the second solder paste is formed into a second sub-solder layer 2b.

The second solder paste is prepared by mixing a second metal solder material and a second organic medium. The second metal solder material includes a metal tin (Sn), a metal copper (Cu), and selectively includes a second active metal.

Preferably, the second metal solder material is composed of the metal tin (Sn), the metal copper (Cu), and the second active metal, and the second solder paste does not contain any metal silver (Ag).

In the second metal solder material, a weight ratio of the metal tin (Sn), the metal copper (Cu), and the second active metal is 20 to 50:40 to 70:0.5 to 10, and is preferably 32.5 to 42.5:52.5 to 62.5:2 to 8. For example, the weight ratio of the metal tin (Sn), the metal copper (Cu), and the second active metal is 37.5:57.5:5, but the present disclosure is not limited thereto.

In some embodiments, the second active metal can be selected from the group consisting of: titanium (Ti), zirconium (Zr), tantalum (Ta), niobium (Nb), vanadium (V), hafnium (Hf), and a metal hydride of any one of the above-mentioned metals. For example, the metal hydride can be selected from the group consisting of: titanium hydride (TiH₂), zirconium hydride (ZrH₂), tantalum hydride (TaH₂), niobium hydride (NbH), vanadium hydride (VH₂), and hafnium hydride (H₂Hf₂). Preferably, the second active metal is at least one of titanium (Ti) and titanium hydride (TiH₂).

In the present embodiment, the metal tin (Sn), the metal copper (Cu), and the second active metal are dispersed in the second organic medium in the form of metal powders, so as to prepare the second solder paste.

Specifically, the second organic medium includes a paste forming agent, a thixotropic agent, and an organic solvent. In the second organic medium, a weight ratio of the paste forming agent, the thixotropic agent, and the organic solvent is 20 to 30:1 to 5:50 to 70. The material types of the paste forming agent, the thixotropic agent, and the organic solvent are similar to those of the first organic medium in the first solder paste, and will not be reiterated herein.

More specifically, in the second solder paste, a weight ratio of the second metal solder material and the second organic medium is 70:30 to 95:5, and preferably is 80:20 to 90:10.

Preferably, the second solder paste is formulated to have a viscosity of between 50 mPa·s and 300 mPa·s (at a room temperature of 25° C.), so that the second solder paste can be easily coated onto the first sub-solder layer 2a, and shape formation can be easily achieved.

In one embodiment of the present disclosure, the second solder paste can be coated onto the side surface of the first sub-solder layer 2a by screen printing, and can be dried at a high temperature of between 90° C. and 110° C. for 5 minutes to 15 minutes, so that most of the organic solvent in the second solder paste is volatilized, and the second sub-solder layer 2b can be formed.

A thickness T22 of the second sub-solder layer 2b is between 6 micrometers and 24 micrometers, and is preferably between 18 micrometers and 24 micrometers.

Preferably, the thickness T22 of the second sub-solder layer 2b is greater than the thickness T21 of the first sub-solder layer 2a. A thickness ratio (i.e., T22/T21) between the thickness T22 of the second sub-solder layer 2b and the thickness T21 of the first sub-solder layer 2a ranges from 1.5 to 5, preferably ranges from 2 to 4, and more preferably ranges from 2.5 to 3.5.

A metal solder layer 2 is jointly formed by the first sub-solder layer 2a and the second sub-solder layer 2b.

In the metal solder layer 2, based on a total weight of the first metal solder material and the second metal solder material being 100 wt % (i.e., a total weight of the metal tin, the metal copper, the first active metal, and the second active metal being 100 weight percent), a content of the metal tin ranges from 35 wt % to 70 wt %, a content of the metal copper ranges from 20 wt % to 65 wt %, and a total content of the first active metal and the second active metal ranges from 1 wt % to 20 wt %.

It is worth mentioning that, in the embodiment of the present disclosure, the metal solder layer 2 does not contain any metal silver (Ag).

As shown in FIG. 2D, step S140 includes: disposing a conductive metal layer 3 onto a side surface of the second sub-solder layer 2b that is away from the first sub-solder layer 2a, such that the conductive metal layer 3 can be connected to the ceramic substrate 1 through the metal solder layer 2 formed by the first sub-solder layer 2a and the second sub-solder layer 2b, and an active metal ceramic substrate E can be formed.

The conductive metal layer 3 can be a metal copper foil, a metal aluminum foil, or a copper aluminum alloy foil. In the present embodiment, the conductive metal layer 3 is preferably the metal copper foil. In addition, a thickness T3 of the conductive metal layer 3 can be, for example, between 50 micrometers and 1,200 micrometers, but the present disclosure is not limited thereto.

Step S150 includes: performing a high-temperature vacuum sintering process to tightly braze the conductive metal layer 3 onto the ceramic substrate 1 through the metal solder layer 2 formed by the first sub-solder layer 2a and the second sub-solder layer 2b.

An operation temperature of the high-temperature vacuum sintering process is between 600° C. and 900° C., and is preferably between 700° C. and 900° C.

It is worth mentioning that, in the above-mentioned high-temperature vacuum sintering process, the active metal (e.g., Ti) in the first sub-solder layer 2a can wet a surface of the ceramic substrate 1, and the active metal can react with a ceramic material (e.g., SiN) to form compounds, such as titanium nitride (TiN), titanium silicon oxide (TiSi), or titanium disilicate (TiSi₂). In this way, a bonding force between the conductive metal layer 3 and the ceramic substrate 1 can be improved.

In addition, when being in the high-temperature vacuum sintering process, the metal tin (Sn) and the metal copper (Cu) in the second sub-solder layer 2b can be melted into a fluid state and react with each other, so that the conductive metal layer 3 and the ceramic substrate 1 have a good bonding force.

For example, when the operation temperature of the high-temperature vacuum sintering process is greater than 600° C., the metal tin can firstly react with the metal copper to form a Cu₃Sn alloy. Furthermore, the CusSn alloy can react with more of the metal tin to form a Cu₆Sn₅ alloy. Accordingly, the second sub-solder layer 2b can be connected to the conductive metal layer 3 more tightly, such that the bonding force between the conductive metal layer 3 and the ceramic substrate 1 can be improved.

According to the above configuration, the metal solder layer 2 can improve the bonding force between the ceramic substrate 1 and the conductive metal layer 3.

It is worth mentioning that since the metal solder layer 2 does not contain any metal silver (Ag), an issue of electro-migration caused by silver residue in the related art can be effectively avoided, and the manufacturing costs can be reduced.

In addition, in the present embodiment, the first sub-solder layer 2a, the second sub-solder layer 2b, and the conductive metal layer 3 are sequentially disposed on only one side surface of the ceramic substrate 1. However, the present disclosure is not limited thereto. For example, as shown in FIG. 3, in another embodiment of the present disclosure, another first sub-solder layer 2a′, another second sub-solder layer 2b′, and another conductive metal layer 3′ can also be sequentially disposed onto another side surface of the ceramic substrate 1. In this way, an active metal ceramic substrate E′ having the metal solder layer 2 disposed on each of both side surfaces of the ceramic substrate 1 can be formed.

### Experimental Data and Test Results

Hereinafter, a detailed description will be provided with reference to Exemplary Example 1. However, the present disclosure is not limited thereto.

A preparation method of Exemplary Example 1 includes: coating, according to the conditions shown in Table 1, a first solder paste that includes a first metal solder material and a first organic medium onto a side surface of a ceramic substrate, and drying the first solder paste at a high temperature, so as to form a first sub-solder layer. The first metal solder material is titanium (Ti) powders (i.e., an active metal), and a thickness of the first sub-solder layer is 6 micrometers. In addition, the ceramic substrate is a silicon nitride ceramic substrate. Then, a second solder paste that includes a second metal solder material and a second organic medium is coated onto the first sub-solder layer, and is dried at a high temperature to form a second sub-solder layer. The second metal solder material includes tin (Sn) powders, copper (Cu) powders, and titanium (Ti) powders with a weight ratio of 37.5:57.5:5, and a thickness of the second sub-solder layer is 18 micrometers. In each of the first solder paste and the second solder paste, a weight ratio between the metal solder material and the organic medium is 80:20. In the organic medium, a paste forming agent is ethyl cellulose, an organic solvent is ethylene glycol butyl ether acetate, and a thixotropic agent is polyamide wax. A weight ratio of the paste forming agent, the organic solvent, and the thixotropic agent is 25:60:15. The first solder paste and the second solder paste do not contain any metal silver. Afterwards, a metal copper foil is further disposed on the second sub-solder layer to form an active metal ceramic substrate. In Exemplary Example 1, the active metal ceramic substrate is further subjected to high-temperature vacuum sintering at a brazing temperature of 855° C. Then, a temperature of the active metal ceramic substrate is lowered to a room temperature, and a tensile force test is performed on the active metal ceramic substrate.

The tensile force test is used to measure a tensile force between the metal copper foil and the ceramic substrate according to the JIS-C-6481 standard. A measurement temperature is 25° C. If the tensile force is greater than 100 N/cm, a bonding strength is evaluated as good. If the tensile force falls within a range of from 50 N/cm to 100 N/cm, the bonding strength is evaluated as normal. If the tensile force is less than 50 N/cm, the bonding strength is evaluated as poor.

TABLE 1

| | first sub-solder layer | | |
|---|---|---|---|
| Items | metal composition | weight ratio (%) | thickness (μm) |
| Exemplary | Ti | 100 | 6 |
| Example 1 | | | |

| | second sub-solder layer | | | brazing | |
|---|---|---|---|---|---|
| | metal | weight | thickness | temperature | tensile force |
| Items | composition | ratio (%) | (μm) | (° C.) | (N/cm) |
| Exemplary | Sn—Cu—Ti | 37.5:57.5:5 | 18 | 855 | 106 |
| Example 1 | | | | | |

From the test results shown in Table 1, the active metal ceramic substrate of Exemplary Example 1 has a tensile force of 106 N/cm, and has good tensile strength performance.

It is worth mentioning that the active metal ceramic substrate of the above-mentioned Exemplary Example 1 can still have good tensile strength performance even if the metal solder layer does not contain any metal silver, which is a breakthrough from the limitation of using the metal silver in an active metal layer in the related art.

### Beneficial Effects of the Embodiment

In conclusion, in the method for producing the active metal ceramic substrate provided by the present disclosure, by virtue of “coating a first solder paste onto a side surface of a ceramic substrate, and drying the first solder paste to form a first sub-solder layer, in which the first solder paste is prepared by mixing a first metal solder material and a first organic medium, the first metal solder material includes a first active metal and does not contain a metal silver (Ag), and a thickness of the first sub-solder layer is between 1 micrometer and 10 micrometers” and “coating a second solder paste onto a side surface of the first sub-solder layer that is away from the ceramic substrate, and drying the second solder paste to form a second sub-solder layer, in which the second solder paste is prepared by mixing a second metal solder material and a second organic medium, the second metal solder material includes a metal tin (Sn) and a metal copper (Cu), and selectively includes a second active metal, the second metal solder material does not contain a metal silver (Ag), and a thickness of the second sub-solder layer is between 6 micrometers and 24 micrometers,” the metal solder layer of the active metal ceramic substrate does not require the use of the metal silver (Ag).

Through the configuration of the first sub-solder layer and the second sub-solder layer in the above-mentioned metal solder layer, the metal solder layer can improve the bonding force between the ceramic substrate and the conductive metal layer. It is worth mentioning that since the metal solder layer does not contain any metal silver (Ag), the issue of electro-migration caused by silver residue in the related art can be effectively avoided, and the manufacturing costs can be reduced.

Lastly, through etching a circuit pattern on the ceramic substrate by exposure and development, the active metal ceramic substrate of the present disclosure can be applied to a high-power module for energy conversion, an electric vehicle, and a charging system.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing an active metal ceramic substrate, comprising:
coating a first solder paste prepared by mixing a first metal solder material and a first organic medium onto a side surface of a ceramic substrate, and drying the first solder paste to form a first sub-solder layer; wherein the first metal solder material includes a first active metal, and does not contain a metal silver (Ag); wherein a thickness of the first sub-solder layer is between 1 micrometer and 10 micrometers;
coating a second solder paste prepared by mixing a second metal solder material and a second organic medium onto a side surface of the first sub-solder layer that is away from the ceramic substrate, and drying the second solder paste to form a second sub-solder layer; wherein the second metal solder material includes a metal tin (Sn) and a metal copper (Cu), and selectively includes a second active metal, and the second metal solder material does not contain a metal silver (Ag); wherein a thickness of the second sub-solder layer is between 6 micrometers and 24 micrometers; and
disposing a conductive metal layer onto a side surface of the second sub-solder layer that is away from the first sub-solder layer, so as to form the active metal ceramic substrate.

2. The method according to claim 1, further comprising: performing a high-temperature vacuum sintering process to braze the conductive metal layer onto the ceramic substrate through the first sub-solder layer and the second sub-solder layer.

3. The method according to claim 2, wherein an operation temperature of the high-temperature vacuum sintering process is between 600° C. and 900° C.

4. The method according to claim 1, wherein the thickness of the second sub-solder layer is greater than the thickness of the first sub-solder layer, and a thickness ratio between the second sub-solder layer and the first sub-solder layer ranges from 1.5 to 5.

5. The method according to claim 1, wherein the thickness of the first sub-solder layer is between 1 micrometer and 6 micrometers, and the thickness of the second sub-solder layer is between 18 micrometers and 24 micrometers.

6. The method according to claim 1, wherein the first active metal is selected from the group consisting of titanium (Ti), zirconium (Zr), tantalum (Ta), niobium (Nb), vanadium (V), hafnium (Hf), titanium hydride (TiH₂), zirconium hydride (ZrH₂), tantalum hydride (TaH₂), niobium hydride (NbH), vanadium hydride (VH₂), and hafnium hydride (H₂Hf₂), and the second active metal is selected from the group consisting of titanium (Ti), zirconium (Zr), tantalum (Ta), niobium (Nb), vanadium (V), hafnium (Hf), titanium hydride (TiH₂), zirconium hydride (ZrH₂), tantalum hydride (TaH₂), niobium hydride (NbH), vanadium hydride (VH₂), and hafnium hydride (H₂Hf₂).

7. The method according to claim 1, wherein the first solder paste has a viscosity of between 50 mPa·s and 300 mPa·s, and the second solder paste has a viscosity of between 50 mPa·s and 300 mPa·s.

8. The method according to claim 1, wherein, in the first solder paste, the first metal solder material is only formed by the first active metal, the first organic medium includes a paste forming agent, a thixotropic agent, and an organic solvent, and a weight ratio of the paste forming agent, the thixotropic agent, and the organic solvent is 20 to 30:1 to 5:50 to 70.

9. The method according to claim 1, wherein, in the second solder paste, the second metal solder material is formed by the metal tin (Sn), the metal copper (Cu), and the second active metal, and a weight ratio of the metal tin (Sn), the metal copper (Cu), and the second active metal is 20 to 50:40 to 70:0.5 to 10; wherein the second organic medium includes a paste forming agent, a thixotropic agent, and an organic solvent, and a weight ratio of the paste forming agent, the thixotropic agent, and the organic solvent is 20 to 30:1 to 5:50 to 70.

10. The method according to claim 9, wherein, in the second metal solder material, the weight ratio of the metal tin (Sn), the metal copper (Cu), and the second active metal is 32.5 to 42.5:52.5 to 62.5:2 to 8.
